(19) United States
(12) Patent Application Publication
(10) Pub. No.: US 2007/0029410 A1
(43) Pub. Date: Feb. 8, 2007

(54) Fuel injection valve for internal combustion engines

(76) Inventors: Thomas Kuegler, Korntal-Muenchingen (DE); Hasiman Üsküdar, Bursa (TR)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/571,099

(22) PCT Filed: Jul. 22, 2004
(86) PCT No.: PCT/DE04/01624

§ 371 Date: Mar. 8, 2006

(30) Foreign Application Priority Data
Sep. 9, 2003 (DE) 103 41 452.5

(51) Int. Cl. F02M 47/02; F02M 63/00; F02M 51/00

(52) U.S. Cl. 239/533.2; 239/88; 239/585.5

(57) ABSTRACT

A fuel injection valve for internal combustion engines, having an outer valve seat embodied in a valve body and has a conical shape with an outer opening angle, from which at least one outer injection opening leads. A likewise conical inner valve seat is also provided, which has an inner opening angle, from which at least one inner injection opening leads. The valve body contains a hollow valve needle that has an outer valve sealing surface with which it cooperates with the outer valve seat, thus controlling the opening of the at least one outer injection opening. The hollow valve needle contains a valve needle that has an inner valve sealing surface with which it cooperates with the inner valve seat to control the at least one inner injection opening; the opening angles of the inner valve seat and outer valve seat are different from each other.

### PRIOR ART

The present invention is based on a fuel injection valve for internal combustion engines as generically defined by the preamble to claim 1. A fuel injection valve of this kind is known, for example, from WO 02/42637 and has a housing in which an outer and inner valve seat are provided. At least one inner and outer injection opening respectively extend from the two valve seats and feed into the combustion chamber of the internal combustion engine. The fuel injection valve contains a hollow valve needle that cooperates with the outer valve seat to control the outer injection openings. In addition, the hollow valve needle contains a valve needle whose inner valve sealing surface cooperates with the inner valve seat, thus controlling the inner injection openings.

In the known fuel injection valve, the outer valve seat and the inner valve seat are provided on a shared conical surface and therefore have the same opening angle. The hydraulic opening force and its curve largely depend on the time and pressure at which the respective valve sealing surfaces are acted on by the fuel that flows to the injection openings. The pressure to which the valve sealing surface is subjected and the stroke of the valve needle at which this occurs depend essentially on the opening angle of the valve sealing surface. If, as is the case in the known fuel injection valve, both of the valve seats are situated on a shared conical surface, then it is only possible to change this design parameter for both the hollow valve needle and the valve needle at the same time. This complicates the task of achieving an optimal design and selectively setting the opening dynamics as desired.

### ADVANTAGES OF THE INVENTION

The fuel injection valve according to the present invention, with the characterizing features of claim 1, has the advantage over the prior art that the opening dynamics of the valve needles and the entry conditions at the respective injection openings can be optimized independently of each other. To this end, the valve seats are provided with different opening angles; the opening angles can be optimized with regard to the desired properties of the hollow valve needle and the valve needle.

Advantageous embodiments of the subject of the present invention are possible by means of the measures taken in the dependent claims. An opening angle of 55° to 65° on the inner valve seat has turned out to be advantageous if at the same time, the opening angle of the outer valve seat is greater than this value. It is also possible for the opposite to be true, i.e. for the outer valve seat to have an opening angle of approximately 60° while the inner valve seat has a larger opening angle.

In order to avoid turbulence and provide a uniform flow of fuel between the valve needles and the valve seats, these components preferably adjoin one another directly. Additional edges are grooves in this region can have a negative impact on the flow toward the injection openings.

Other advantages ensue from the description and the drawings.

### DRAWINGS

Various exemplary embodiments of the present invention are shown in the drawings.

FIG. 1 shows a longitudinal section through a fuel injection valve,

FIG. 2 is an enlarged depiction in the region of the valve seat of a first exemplary embodiment, and

FIG. 3 shows another exemplary embodiment, in a depiction equivalent to the one shown in FIG. 2.

### DESCRIPTION OF THE EXEMPLARY EMBODIMENTS

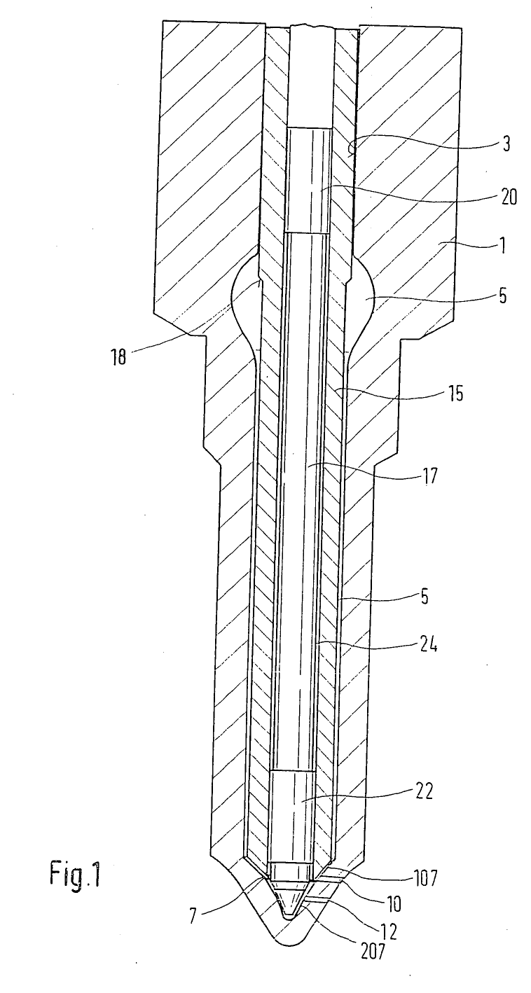

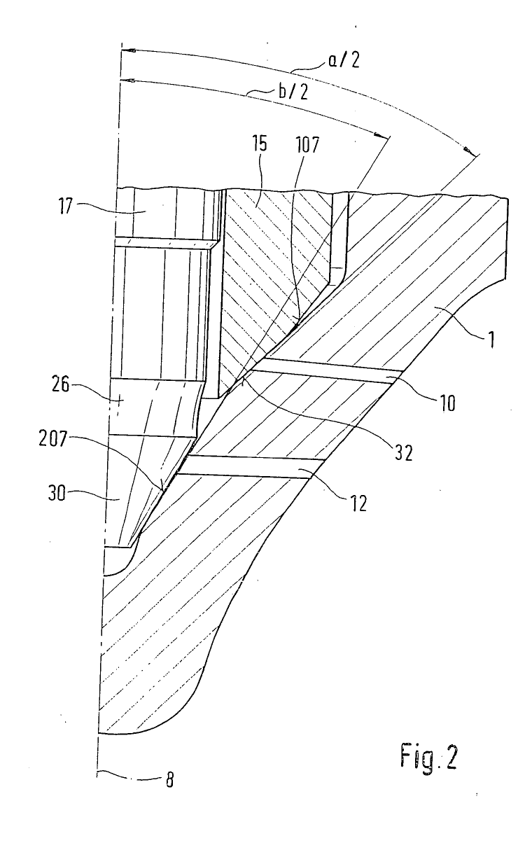

FIG. 1 shows a longitudinal section through a fuel injection valve according to the present invention. A valve body 1 contains a bore 3 whose end oriented toward the combustion chamber is delimited by a valve seat 7. The valve seat 7 here is comprised of an outer valve seat 107 and in inner valve seat 207, both of which are conical. At least one outer injection opening 10 leads from the outer valve seat 107 and at least one inner injection opening 12 leads from the inner valve seat 207; all of the injection openings feed into the combustion chamber when the fuel injection valve is in the installed position. The bore 3 contains a hollow valve needle 15 whose end oriented toward the valve seat has an outer valve sealing surface 32 that cooperates with the outer valve seat 107. To this end, FIG. 2 shows an enlarged depiction of FIG. 1 in the region of the valve seat 7; only half of the valve seat is shown since it is rotationally symmetrical to the longitudinal axis 8 of the bore 3.

A section of the hollow valve needle 15 oriented away from the valve seat is guided in a sealed fashion in the bore 3 and the hollow valve needle 15 tapers toward the valve seat 7 to form a pressure shoulder 18. Between the guided section of the hollow valve needle 15 and the valve seat 7, a pressure chamber 5 that expands radially at the level of the pressure shoulder 18 is formed between the hollow valve needle 15 and the wall of the bore 3. A supply conduit extending in the valve body 1 and not depicted in the drawing feeds into the radial expansion of the pressure chamber 5, thus allowing the pressure chamber 5 to be filled with highly pressurized fuel.

The hollow valve needle 15 contains a valve needle 17 that can slide in the longitudinal direction; an inner valve sealing surface 32 of the valve needle 17 cooperates with the inner valve seat 207. The valve needle 17 has a first guide section 20 and a second guide section 22 with which it is guided in the hollow valve needle 15. Between these guide sections 20, 22 there is an open section, which prevents the valve needle 17 from jamming inside the hollow valve needle 15. At their ends oriented away from the valve seat, both the valve needle 17 and the hollow valve needle 15 are subjected to a closing force that is generated by a device not shown in the drawing. Such devices, which are adequately known from the prior art, can, for example, be springs or control chambers that generate the closing force hydraulically. The hollow valve needle 15 and the valve needle 17 are controlled by means of the ratio of the closing forces to the hydraulic opening forces acting on the pressure shoulder 18 of the hollow valve needle 15 and on a pressure shoulder 26 on the valve needle 17. If the closing force acting on the hollow valve needle 15 falls below the opening forces acting on it, then it lifts away from the outer valve seat 107, thus connecting the pressure chamber 5 to the outer injection openings 10. The highly pressurized fuel in the pressure chamber 5 then flows through between the outer valve sealing surface 32 and the outer valve seat 107 and is injected into the combustion chamber through the outer injection openings 10. After the hollow valve needle 15 lifts away from the valve seat 7, fuel acts on the pressure shoulder 26 of the valve needle 17, thus generating a corresponding hydraulic opening force on the valve needle 17. Depending on the closing force acting on the valve needle 17, it either remains in its closed position or it also lifts away from the inner valve seat 207, thus opening the inner injection openings 12 in the same way as the hollow valve needle 15 has done. In this way, it is possible for fuel to be injected into the combustion chamber through either only the outer injection openings 10 or through all of the injection openings 10, 12, thus providing a variable injection cross section.

FIG. 2 is an enlarged depiction of the region of the valve seat 7. The outer valve seat 107 and the inner valve seat 207 are embodied as respective conical surfaces. The outer valve seat 107 here has an opening angle a and the inner valve seat 207 has an opening angle b; due to the form of the depiction, the drawing shows the half angles a/2, b/2. The opening angles of the valve seats 107, 207 are embodied differently, for example in order to optimize the influx conditions of the fuel into the injection openings 10, 12. After the hollow valve needle 15 opens, i.e. after it lifts away from the outer valve seat 107, the fuel, driven by the high pressure in the pressure chamber 5, begins to flow at high speed toward the outer injection openings 10. Upon entry into the outer injection openings 10, the fuel must execute a direction change that essentially depends on the opening angle a. The opening angle b of the inner valve seat 207 likewise influences the conditions of the influx into the inner injection openings 12. Since the inner and outer injection openings 10, 12 frequently have different diameters or enclose different angles with the longitudinal axis 8. The different opening angles of the outer valve seat 107 and the inner valve seat 207 can be used to adapt these influx conditions specifically to the respective injection openings 10, 12.

In addition, the opening angle of the valve seats 107, 207 can be used to set the opening dynamics of the hollow valve needle 10 and the valve needle 12: after the valve needles have lifted away from the valve seats 107, 207, the fuel pressure also acts on the valve sealing surfaces 30, 32, thus generating an additional opening force that essentially determines the dynamics of the opening motion. The intensity of this opening force depends in particular on the opening angles a, b of the valve seats 107, 207, thus making it possible to also optimize the opening dynamics by means of the opening angles of the valve seats 107, 207.

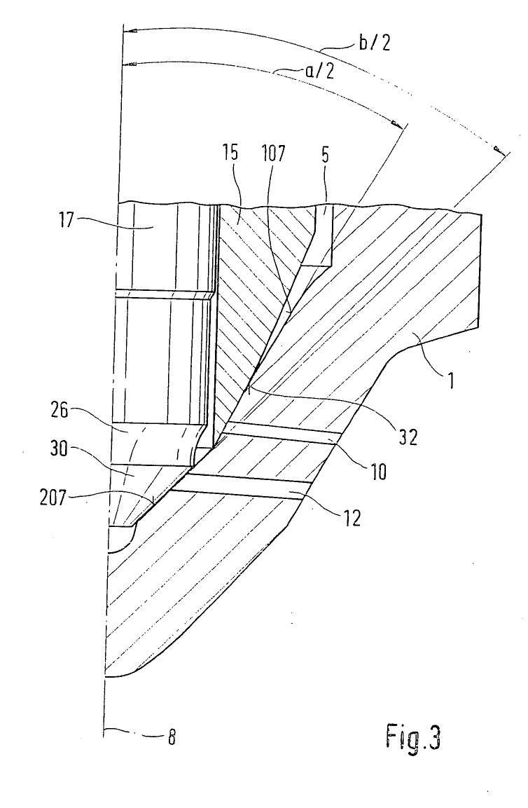

FIG. 3 shows another exemplary embodiment in a depiction equivalent to the one shown in FIG. 2. It corresponds in all essential features to the exemplary embodiment shown in FIG. 2, but in this case, the opening angle a of the outer valve seat 107 is smaller than the opening angle b of the inner valve seat 207. Preferable values for the opening angle are from 85° to 95°, preferably approximately 90°, for the larger opening angle, i.e. the opening angle a in FIG. 2 and the opening angle b in FIG. 2. The smaller opening angles are from 55° to 65°, preferably approximately 60°.

1-7. (canceled)

8. In a fuel injection valve for internal combustion engines, having an outer valve seat, which is embodied in a valve body and which has a conical shape with an outer opening angle (a), from which at least one outer injection opening leads; having a likewise conical inner valve seat, which has an inner opening angle (b), from which at least one inner injection opening leads; having a hollow valve needle contained in the valve body and having an outer valve sealing surface with which it cooperates with the outer valve seat to control the opening of the at least one outer injection opening; and having a second valve needle, which is contained in the hollow valve needle and having an inner valve sealing surface with which it cooperates with the inner valve seat to control the at least one inner injection opening, the improvement wherein the opening angles (a, b) of the inner valve seat and outer valve seat are different from each other.

9. The fuel injection valve according to claim 8, wherein the inner valve seat and the outer valve seat are situated concentric to each other.

10. The fuel injection valve according to claim 8, wherein the opening angle (b) of the inner valve seat is smaller than that of the outer valve seat.

11. The fuel injection valve according to claim 9, wherein the opening angle (b) of the inner valve seat is smaller than that of the outer valve seat.

12. The fuel injection valve according to claim 10, wherein the opening angle (b) of the inner valve seat is from about 85° to about 95°.

13. The fuel injection valve according to claim 11, wherein the opening angle (b) of the inner valve seat is from about 85° to about 95°.

14. The fuel injection valve according to claim 8, wherein the outer valve seat has an opening angle (a) that is smaller than the opening angle (b) of the inner valve seat.

15. The fuel injection valve according to claim 9, wherein the outer valve seat has an opening angle (a) that is smaller than the opening angle (b) of the inner valve seat.

16. The fuel injection valve according to claim 14, wherein the opening angle (b) of the outer valve seat is from about 85° to about 95°.

17. The fuel injection valve according to claim 15, wherein the opening angle (b) of the outer valve seat is from about 85° to about 95°.

18. The fuel injection valve according to claim 8, wherein the inner valve seat directly adjoins the outer valve seat.
